(19) United States
(12) Patent Application Publication
(10) Pub. No.: US 2016/0244654 A1
(43) Pub. Date: Aug. 25, 2016

(54) SOLIDS IN BOREHOLE FLUIDS

(71) Applicant: SCHLUMBERGER TECHNOLOGY BV, The Hague (NL)

(72) Inventors: Paul WAY, Cambridge (GB); David SNOSWELL, Cambridge (GB); John Mervyn COOK, Cambridge (GB); Louise BAILEY, Cambridge (GB); Gokturk TUNC, Houston, TX (US); Elizabeth Alice Gilchrist JAMIE, Cambridge (GB); Walter ALDRED, Cambridge (GB)

(21) Appl. No.: 15/024,251

(22) PCT Filed: Sep. 23, 2014
(86) PCT No.: PCT/IB2014/064746

§ 371 Date: Mar. 23, 2016

(30) Foreign Application Priority Data
Sep. 23, 2013 (GB) 1316898.4
Oct. 4, 2013 (GB) 1317626.8

(51) Int. Cl. C09K 8/035

(52) U.S. Cl. CPC C09K 8/035

(57) ABSTRACT

A drilling fluid for use when drilling a borehole includes solid polymeric objects as a lost circulation additive. The objects have an overall size extending at least 0.5 mm in each of three orthogonal dimensions have a shape such that each object has one or more edges, points or corners and/or comprises a core portion with a plurality of projections which extend out from the core portion. The objects may be moulded, 3D-printed or chopped from larger pieces of polymer by granulating machinery. Shapes with edges, points, corners or projections assisting the objects in lodging within and bridging a fracture encountered or formed while drilling.

### BACKGROUND

A considerable range of fluids are used in the creation and operation of subterranean boreholes. These fluids may contain suspended solids for a number of purposes. Included within this broad category are drilling fluids which may contain suspended solids. One possibility is that a drilling fluid contains solid particles specifically intended to block fractures in formation rock and mitigate so-called lost circulation.

Lost circulation, which is the loss of drilling fluid into downhole earth formations, can occur naturally in formations that are fractured, porous, or highly permeable. Lost circulation may also result from induced pressure during drilling. Lost circulation may also be the result of drilling-induced fractures. For example, when the pore pressure (the pressure in the formation pore space provided by the formation fluids) exceeds the pressure in the open borehole, the formation fluids tend to flow from the formation into the open borehole. Therefore, the pressure in the open borehole is typically maintained at a higher pressure than the pore pressure. However, if the hydrostatic pressure exerted by the fluid in the borehole exceeds the fracture resistance of the formation, the formation is likely to fracture and thus drilling fluid losses may occur. Moreover, the loss of borehole fluid may cause the hydrostatic pressure in the borehole to decrease, which may in turn also allow formation fluids to enter the borehole. The formation fracture pressure typically defines an upper limit for allowable borehole pressure in an open borehole while the pore pressure defines a lower limit. Therefore, a major constraint on well design and selection of drilling fluids is the balance between varying pore pressures and formation fracture pressures or fracture gradients though the depth of the well.

Several remedies aiming to mitigate lost circulation are available. These include the addition of particulate solids to drilling fluids, so that the particles can enter the opening into a fracture and plug the fracture or bridge the opening to seal the fracture. Documents which discuss such “lost circulation materials” include U.S. Pat. No. 8,401,795 and Society of Petroleum Engineers papers SPE 58793, SPE 153154 and SPE 164748.

One proposal to use particles of organic polymer as lost circulation material is U.S. Pat. No. 7,284,611 which mentions ground thermoset polymer laminate. Particle shape is not mentioned. One supplier of such material refers to it as flakes. This document also mentions an elastomer: again shape is not mentioned. U.S. Pat. No. 7,799,743 mentions granules of polypropylene, which is a thermoplastic polymer and requires particles to have an average resiliency of at least 10% rebound after compression of a quantity of articles by a pressure of 0.4 MPa. The shape of the particles is not mentioned.

### SUMMARY

This summary is provided to introduce a selection of concepts that are further described below. This summary is not intended to be used as an aid in limiting the scope of the subject matter claimed.

As now disclosed herein, a borehole fluid comprises suspended solid particles which are objects formed of polymeric material and which meet requirements as to size and shape. The fluid may be a drilling fluid and the particles in the fluid may be present in the fluid as a measure to counteract or mitigate loss of fluid into fractures in the formation being drilled. If a fracture is created in a formation during drilling or if a natural fracture is encountered, the fluid entering the fracture can carry some of the solid particles into the fracture, for them to form a bridge or plug which restricts or closes the pathway for fluid loss. The particles may themselves block the fracture or they may act jointly with other solids in the fluid to form a plug which closes the fracture.

The present disclosure provides a borehole fluid containing suspended solid particles which are objects formed of a polymeric material and having sufficient rigidity to sustain their own shape, wherein the objects have an overall size extending at least 0.5 mm in each of three orthogonal dimensions, and possibly at least 1 mm in each of three orthogonal dimensions wherein the particles have a shape such that each particle has one or more edges, points or corners and/or comprises a core portion with a plurality of projections which extend out from the core portion.

These objects have features of shape such that they are not smooth globules. It is envisaged that this will reduce their ability to slide over the fracture faces or one another, so assisting them to form a bridge across a crack or fracture.

There are several possibilities for shapes, and these possibilities are not mutually exclusive. One possibility is that an object has a shape which is at least partially bounded by surfaces which intersect at an edge. Angles between at least some edges may possibly be not more than 150° and may be less such as not more than 120° or not more than 100°. There may be distinct corners where three surfaces and three edges meet. A corner may be such that the included angle in each of two planes intersecting at right angles is not more than 120° and possibly not more than 100°. An alternative parameter is solid angle: a corner may be such that the included solid angle is not more than 1.7 steradians, which is slightly more than the solid angle (0.5π steradians) subtended by the corner of a cube.

Another possibility is that a shape may include one or more points. A point may be such that one or more surfaces which converge to the point include a solid angle of not more than 1 steradian and possibly include a solid angle of not more than 0.8 or 0.7 steradian. A cone with an angle of 35° includes approximately 1 steradian and a cone with an angle of 30° includes 0.78 steradian. A point may be a corner at which a plurality of surfaces coincide and include a solid angle which is less than the solid angle at the corner of a cube, or it may be formed by the convergence of a single surface, as is the case with the tip of a cone. Yet another possibility for a shape is a projection from a core. Projections from a core may possibly extend out from the core for a distance which is greater than the distance across the core itself. Projections may terminate in a point or corner or may terminate in a flat face.

Shapes with edges, corners, points or projections are able to lodge in a fracture by engaging with each other or by engaging with the formation rock.

It is envisaged that the objects will be rigid under surface conditions to allow mechanical handling of them. Rigidity of the objects may be defined as ability of the objects to maintain their own shape under atmospheric pressure at temperatures up to at least 40° C. and possibly up to higher temperatures such as up to 60° C. However, the objects may have the property of resiliency which may be such that there is an average of at least 10% rebound after compression of a sample quantity of objects with a pressure of 0.4 MPa as specified in U.S. Pat. No. 7,799,743.

When carried downhole in a borehole fluid, the objects will be subjected to hydrostatic pressure above atmospheric, but this may not distort their shape whilst they are suspended in the fluid. If there is any distortion of their shape by pressure on them after they lodge in a fracture, this may assist in plugging the fracture opening.

The polymer may be an organic (i.e carbon based) polymer material commonly referred to as a plastic, which may be a thermoplastic to provide resiliency. Examples of thermoplastic polymers include polystyrene, polyethylene and polypropylene homopolymers and acrylonitrile-butadiene-styrene copolymer. Such polymers may have a specific gravity in a range from 0.7 to 1.3 and possibly in a narrower range from 0.8 to 1.0 or 1.2. It is also possible that the polymer is a polysiloxane which has a polymer chain of silicon and oxygen atoms. Polysiloxanes may have a specific gravity in a ranger from 0.9 or 1.0 up to 1.2 or 1.3. A specific gravity within a range as above may be similar to the specific gravity of a borehole fluid. This is useful for solid objects or particles suspended in a borehole fluid because they will have less tendency to settle out than particles of higher specific gravity and similar size. Settling out of particles can be problematic especially if the circulation of fluid is interrupted. In consequence, objects according to this disclosure may be larger than would be acceptable for particles of higher specific gravity and by reason of larger size they may be suitable for blocking larger fractures.

It is possible that a polymer may be less dense than a borehole fluid. In some embodiments, to mitigate any problems caused by buoyancy of objects, the polymer may be mixed with a denser filler to raise its specific gravity towards neutral buoyancy in the borehole fluid.

The requirement for a size of at least 0.5 mm in at least three dimensions has the consequence that these objects would not fit inside an imaginary sphere of diameter less than 0.5 mm. In some embodiments the objects are larger than this. The objects may have dimensions such that they could fit inside a sphere of 10 mm diameter and possibly inside a sphere of 8 mm, 6 mm or even 5 mm diameter. The objects may be sufficiently large that they could not fit within an imaginary sphere of 1 mm diameter and possibly not within a sphere of 1.5 or 2 mm diameter.

A borehole fluid, which may be a drilling fluid intended to be pumped down a drill string and back to the surface, may contain polymer objects as disclosed above together with another lost circulation material of known type and higher specific gravity, such as graphite particles. Such other lost circulation material may have a mean particle size of at least 10 microns and possibly at least 100 microns. The polymer objects may be used in an amount which is less, by weight and or by volume, than the amount of other lost circulation material(s). For instance the solids incorporated in a drilling fluid to mitigate lost circulation may comprise (i) polymer objects having dimensions too large to fit within a 1 mm diameter sphere and (ii) other solid particles having a mean particle size of at least 10 microns but less than 1 mm, possibly less than 0.5 mm with the volume of particles (ii) being at least 5, possibly at least 10 times the volume of objects (i).

Another possibility is to use polymer particles which are a mixture of sizes. It would be possible to use polymer objects as specified but of more than one size, or polymer objects as specified and other polymer particles of smaller size. For instance polymer particles incorporated in a drilling fluid to mitigate lost circulation may comprise (i) polymer objects as set forth above and having dimensions too large to fit within a 1 mm diameter imaginary sphere and (ii) other organic polymer particles small enough to fit within a 1 mm diameter sphere, with the volume of smaller particles (ii) being at least 5, possibly at least 10 times the volume of the larger objects (i).

Polymer objects as specified above may be present in borehole fluid in an amount which is not more than 3 wt % of the fluid, possibly not more than 1 or 2 wt %. Other solid particles may be present in a greater amount than the sprecified polymer objects.

A further aspect of the present disclosure provides a method of mitigating loss of drilling fluid while drilling a borehole and circulating drilling fluid down and back up the borehole, comprising incorporating polymer objects as set forth above in the drilling fluid.

Polymer objects as set forth above may be made in a number of ways, as will be described in detail below. One possibility, which is a further aspect of the present disclosure, is that polymer objects with intersecting surfaces, edges and/or corners may be made using machinery in which larger pieces of the polymer are sheared by cutting parts moving one past another with very small gap between them, so that the pieces of the polymer are cut through.

### BRIEF DESCRIPTION OF THE DRAWINGS

FIG. 1 diagrammatically illustrates a drill string in a wellbore;

FIG. 2 shows an end view of one example of a drill bit;

FIGS. 3 and 4 show objects which may be made by a comminuting process;

FIG. 3a is a detail of an edge shown in FIG. 3;

FIGS. 5 and 6 show machinery for making the objects of FIGS. 3 and 4;

FIGS. 7, 8 and 9 show objects which may be made by 3D printing;

FIGS. 10 and 11 show objects which may be cast in elastomeric moulds;

FIG. 12 shows a machine for moulding objects; and

FIG. 13 is a view onto a part of the endless belt used in the machine of FIG. 8.

### DETAILED DESCRIPTION

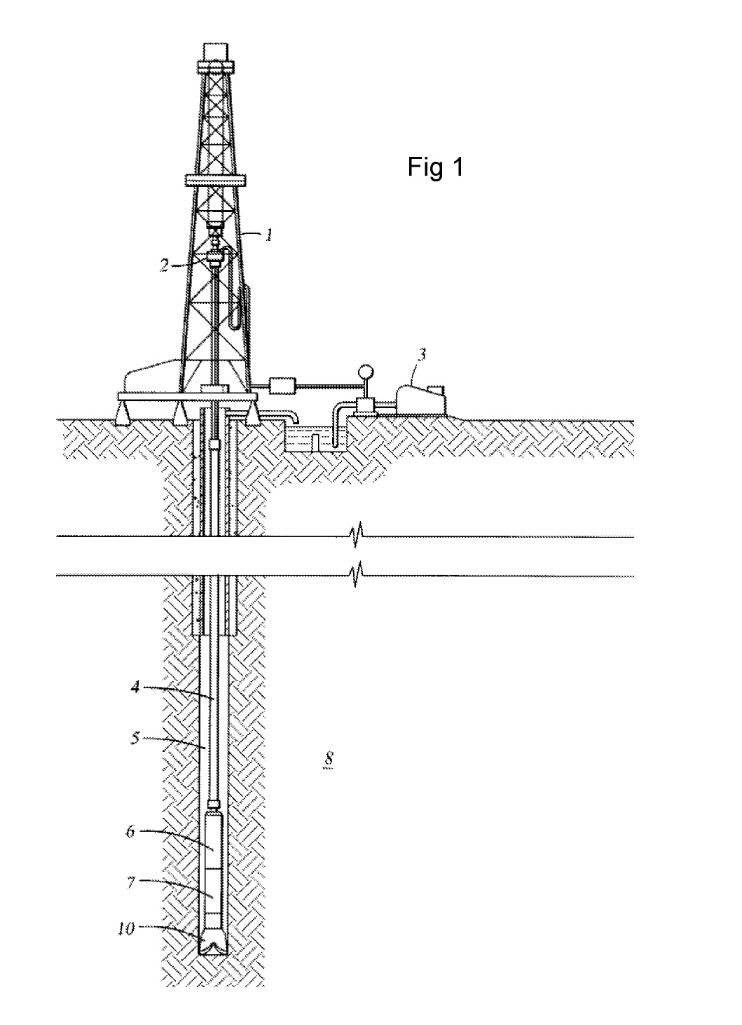

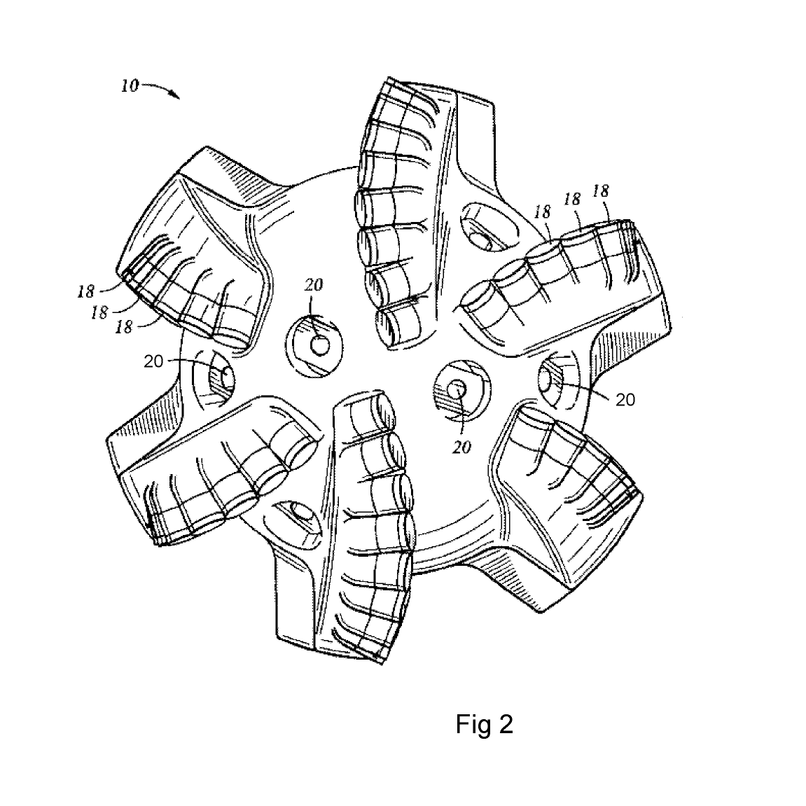

FIG. 1 shows the drilling of a borehole through rock formations 8. The drill bit 10 is coupled to the lower end of a drill string 4, which typically includes segments of drill pipe (not shown separately) coupled together. The drill bit 10 is coupled to the drill string 4 through a bottom hole assembly 6 and 7. The drill string 4 may be rotated by a rotary table (not shown in FIG. 1) or a top drive system 2 which is itself hoisted and lowered by a drilling rig 1. As shown by FIG. 2 the drill bit has a body supporting cutters 18. Drilling fluid (“drilling mud”) is circulated through the drill string 4 by mud pumps 3. The drilling mud is pumped down the interior of the drill string 4 and through the bottom hole assembly to passages through the drill bit 10. These passages through the body of the drill bit terminate at jets 20 shown by FIG. 2 After being discharged through the jets 20, the drilling mud returns to the earth's surface through an annular space 5 around the exterior of the drill string 4 in the borehole.

The circulating drilling fluid provides hydrostatic pressure to prevent the ingress of formation fluids into the wellbore, cools and lubricate the drill string and bit and removes drill cuttings from the bottom of the hole to the surface. Drilling fluid compositions may be water- or oil-based and may include weighting agents, surfactants, polymeric thickeners and other materials.

If there is a fracture in the formation rock penetrated by the borehole, drilling fluid may leak into this fracture and be lost. Polymer objects as disclosed herein may be suspended in drilling fluid as an expedient to block or restrict any such fractures and mitigate fluid loss. The polymer may be an organic (ie carbon-based) polymer. This polymer may be a homopolymer or copolymer. It will have a backbone chain containing carbon atoms and in some polymers, such as polyethylene, the polymer has a continuous chain of carbon atoms. In some other forms of this invention, the polymer backbone may contain oxygen or nitrogen atoms. The organic polymer may overall contain carbon, hydrogen and possibly also oxygen and/or nitrogen atoms and in some forms of this invention the organic polymer also contains a minority proportion (such as less than 10% by number) of other atoms such as sulphur or silicon. In other embodiments, the polymer is a polysiloxane with a polymer chain of silicon and oxygen atoms and carbon atoms in side chains.

Polymer objects with features of shape as mentioned above may be made by several different processes. One possibility is a comminuting process which may be used to cut solid plastic material into objects having edges and corners. Another possibility is to make the objects by an additive manufacturing process which may be a 3-D printing process. A further possibility is to make the objects by a moulding process using an additive manufacturing process in a mould-making stage to make moulds in which the objects are subsequently made in bulk.

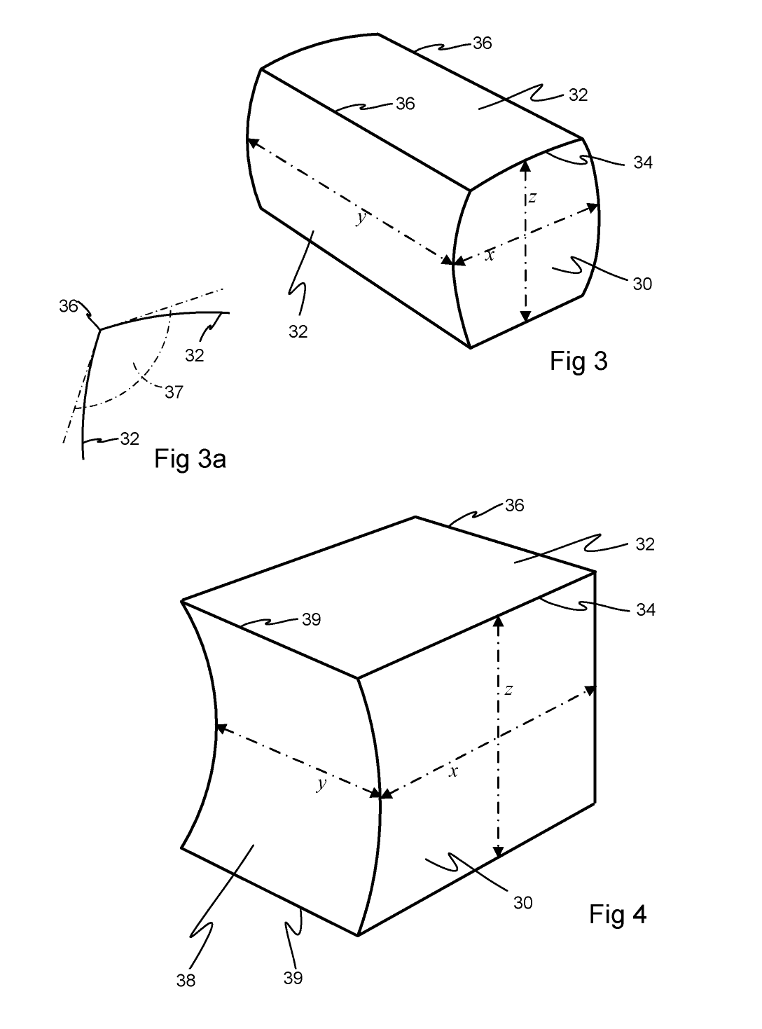

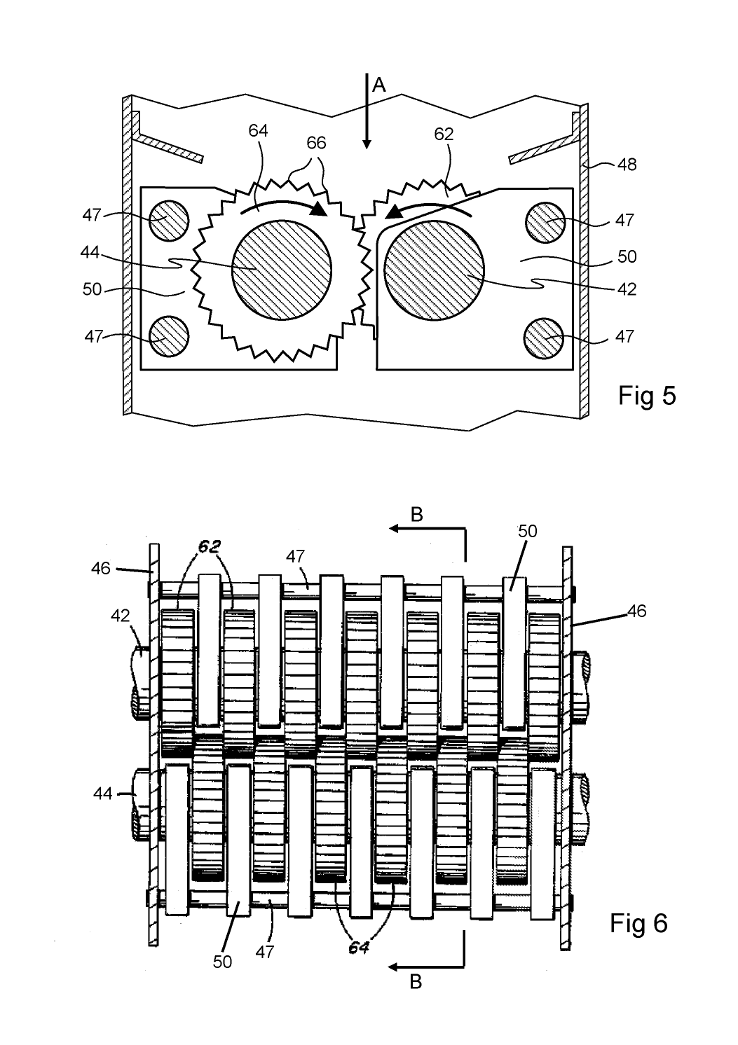

FIGS. 3 and 4 show objects which may be made by a comminuting process. FIGS. 5 and 6 show machinery for cutting larger pieces of polymer to make such objects. The polymer which is cut up may be newly manufactured by polymerisation or it may be recycled material. One possibility is that the polymer is a mixture of polymers provided as recycled rigid plastics.

Machinery for cutting pieces of polymer into smaller pieces may have cutters which move past fixed structure with small clearance or may have cutters which move past other moving cutters with small clearance so that pieces of polymer are sheared through, creating surfaces which are approximately planar. Some forms of machine have a plurality of rotary shafts which each carry a number of spaced cutting wheels which are toothed discs or other shape with parallel faces, with the cutting wheels on one shaft fitting closely within the gaps between cutting wheels on a neighbouring shaft. Such machinery may produce objects with two parallel faces formed by the shearing action of the cutting wheels.

FIGS. 5 and 6 illustrate a granulating machine of this known type. The machine has a granulating assembly comprising two parallel shafts 42, 44 journalled in plates 46 which are connected by fixed rods 47. This assembly is located within a chute 48. The shafts 42, 44 each carry a series of cutting wheels which are toothed discs 62, 64 spaced axially along the shaft. All the cutting wheels 62 and 64 are of equal diameter and thickness and the dimensions are such that (as shown by FIG. 6) wheels 62 on shaft 42 project into the gaps between the wheels 64 on the other shaft 44 and vice versa. Other parts of the gaps between cutting wheels 62 64 discs are partially filled by shaped blocks 50 mounted on the rods 47. The shafts 42, 44 are driven so as to rotate in opposite directions as indicated by arrows in FIG. 5. Where the wheels on one shaft project into the gaps between wheels on the other shaft, the clearances are very small, so that the wheels 62, 64 cut with a shearing action.

Pieces of polymer fall down the chute 48 onto the cutting wheels 62, 64 where they are caught by the teeth 66 on the wheels. Pieces of the polymer are then cut off and are carried through the gaps between adjacent wheels, to be discharged into the portion of the chute 48 below this granulating assembly.

FIG. 3 schematically illustrates a polymer object made by cutting with the machine of FIGS. 5 and 6. The object shown in FIG. 3 is approximately cuboidal with two opposite planar faces 30 parallel to each other (only one is visible in FIG. 3) formed as the object is cut from a larger piece. As shown, the cuboidal object has dimensions x, y and z along three orthogonal axes. Each of x, y and z is over 1 mm but none exceeds 5 mm. The distance x between the parallel planar faces 30 is the distance between adjacent cutting wheels 62 and between adjacent wheels 64. The remaining faces 32 can have other shapes and need not be planar. They may for instance be convex as shown. The surfaces 30 meet surfaces 32 at edges 34. For each edge 34, the angle between the two surfaces at the edge (more precisely the angle subtended in a plane perpendicular to both surfaces) is less than 100° and may be approximately 90°. The surfaces 32 intersect each other at edges 36. As shown by FIG. 3a, the angle 37 included at an edge 36 can be taken as the angle between tangents to the surfaces 32 at the edge 36. In this example, these angles are not more than 120°. Where three edges meet at a corner all the angles between edges are less than 120° and two are approximately 90°.

The surfaces of the object may have some surface roughness, not shown in the drawing, which may mean that the edges are not sharp, but when viewed as a whole, the object has visible edges.

FIG. 4 schematically illustrates another object made by cutting with the machine shown in FIGS. 1 and 2. Reference numerals used for FIG. 3 have the same meaning here. The surfaces 32 may be parts of the surface of the larger piece of polymer which is cut by the machine. The slightly concave surface 38 was formed as the tip of a tooth 66 gouged through a piece of polymer and the angles between surfaces 32 and 38 at edges 39 are, in this example, less than 90°.

Another route for manufacturing polymer objects is an additive manufacturing process. An additive manufacturing process may be implemented to construct an object in accordance with a design held in digital form. The process progressively adds material at selected locations within a workspace, so that the added material joins on to material already present. Such a process is termed “additive” because more material is progressively added in order to arrive at the finished article, in contrast with traditional machining processes which remove material from a workpiece in order to create the desired shape. Additive processes can make shapes which would be difficult or impossible to make with another technology. Several additive processes are known and are sometimes referred to as three-dimensional printing (3D-printing) although that term may also be reserved for one or only some of these additive manufacturing processes.

The term “3D printing” may be used for a process which uses a movable printing head to deliver a droplet of a polymerisable liquid composition to each selected location in a succession of layers, adding material at selected locations in each layer and then moving on to the next layer. The composition may for instance be photopolymerisable by ultraviolet or visible light, and the polymerisation is initiated by illuminating the work space with ultra-violet or visible light while the print head delivers droplets of composition to the selected locations. The photopolymerisation joins each droplet onto material which has already been delivered and polymerised. A process of this kind and apparatus for the purpose was described in U.S. Pat. No. 5,287,435 although there have been numerous subsequent developments as for instance disclosed in U.S. Pat. No. 6,658,314 and U.S. Pat. No. 7,766,641.

As polymerisable material which will eventually form the finished object is delivered to the selected locations another material which acts as a temporary support may be delivered to the remaining voxels as described in U.S. Pat. No. 6,658,314. This support material is subsequently removed after all the layers have been completed.

Machines for 3D printing are available from several manufacturers, including Stratasys, located in Edina, Minn. and elsewhere. A commercially available 3D-printing machine may for example print objects within a space slightly larger than a 20 cm cube, printing them as layers each of which has a thickness of 16 or 32 microns and a resolution of about 20 points per mm.

A photopolymerisable composition delivered as droplets to the required locations may contain a variety of materials with reactive groups, such as epoxy groups, acrylate groups and vinyl ether and other reactive olefinic groups, as for instance disclosed in U.S. Pat. No. 7,183,335. The polymerisable formulation may comprise oligomers which incorporate reactive groups able to undergo further polymerisation so as to lengthen polymer chains or able to form cross links between chains. Polymerisation may be free radical polymerisation initiated by means of an initiator compound which is included in the formulation and which is decomposed to liberate free radicals by ultraviolet or visible light.

One example of oligomers which may be used are polyurethanes with attached acrylate groups. The polyurethanes themselves can be formed from di-isocyanates and polymeric diols. The physical and mechanical properties of the eventual polymers can be regulated by the structures, chain lengths and proportions of the di-isocyanates (which can provide rigidity) and the polymeric diols (which provide flexibility) and the amount of cross-linking between polymer chains.

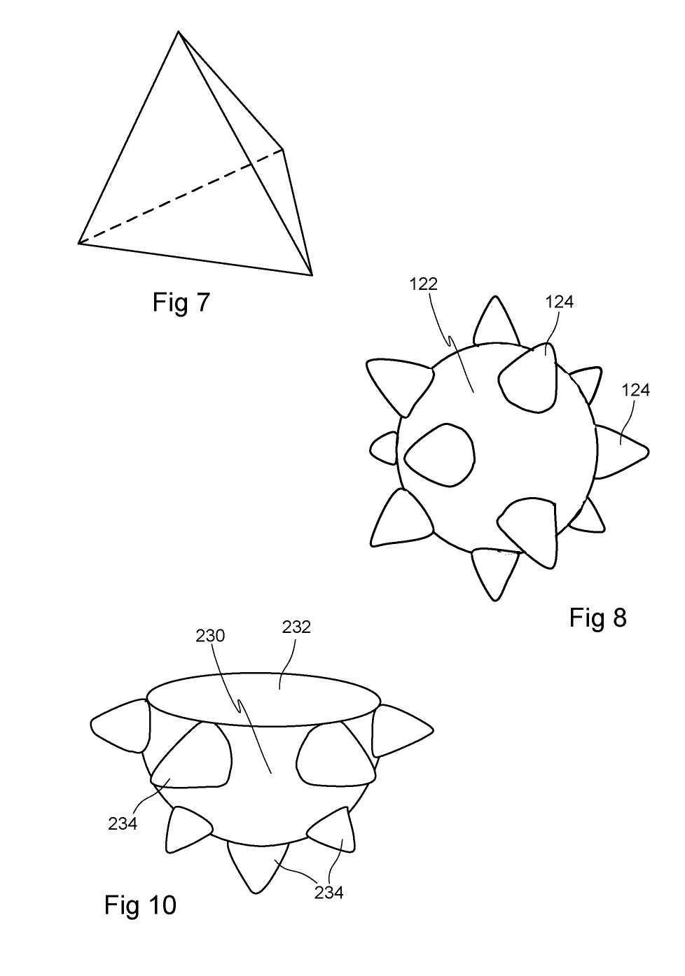

FIG. 7 shows one object which may be made by a 3D printing process. It is a tetragon, which is a symmetrical triangular pyramid with each face formed by an equilateral triangle so that all faces are equal in shape and size. The angle at each corner of each triangular face is of course 60°. If a corner is viewed in two orthogonal directions, the included angles appear as 60° or less. The solid angle included at each corner of a regular tetragon is less than 0.5π steradians. In one example, these tetragons have a length along each side of 1 mm

When carried into a fracture by drilling fluid these tetragons will snag on the rough surface of the rock and will interfere with each other to a greater extent than smooth particles. This assists them in forming a blockage more readily than particles of similar size but with a natural origin and a smoother approximately spheroidal shape. If a fracture opens slightly due to pressure fluctuations, any rolling action of a tetragon along the fracture wall is likely keep the tetragon stationary and jammed if the fracture expansion is less than 20%. The angular shape of a regular tetragon allows it to span two opposite surfaces within a 20% range depending on orientation.

FIG. 8 shows another object which may be made by 3D-printing. It is a sphere with a core 122 and a plurality of conical projections 124 with blunted tips. In an example, the spherical core 122 has a diameter of 3 mm. In this example the number of projections 124 is more than ten but less than twenty and each of these projections 124 extends 1 mm from the core and has a surface which is inclined at an angle of 30° to the axis of the cone so that the solid angle included within the tip of each projection is less than 0.5π steradians, indeed is about 0.78 steradian. These projections will snag on rock and will enable the objects to engage with each other, thus assisting them in bridging and blocking a fracture.

Some 3D-printing machines have the capability to deliver more than one polymerisable material at selected locations as disclosed in U.S. 66/584,314 as well as delivering a temporary support material at other locations, thus enabling an object to be made from two materials. A machine with such capability may be used to print the object of FIG. 8 with rubber-like bendable cones on a more rigid core, or rigid cones on a rubber-like core.

FIG. 9 shows an object which has an approximately spherical core which is completely covered by projections 140 which are each a five or six sided prism. The diameter of the core is less than the length of one of the prisms. In an example the core has a diameter of 0.75 mm and the prisms have a length of 1.95 mm so that the length of the prisms is more than twice the diameter of the core.

As with the tetragon of FIG. 7 and the object of FIG. 8, the projections can snag on rock surfaces which helps them to start forming a bridge across a fracture. The elongate prisms projecting from one object can fit in between those projecting from another object of the same shape which enables a number of the objects to connect together and form a bridge near the mouth of a fracture. Further objects and other solids may then collect on this bridge and form a blockage closing the mouth of the fracture.

Another possibility for manufacture of objects is to cast them from a curable liquid in a mould and then release them from the mould. The mould may be made by a 3D printing process so as to utilise the ability of 3d printing to make complex shapes, but in a mould-making stage rather than in production of the objects.

The moulds may be formed of a flexible polymer and used in a procedure where the moulds are filled with a curable liquid, the composition in the moulds is cured to a solid state and the objects are ejected by bending the moulds. This may be implemented as a process in which the moulds are formed in a moving belt which travels around a bend where the cured objects are ejected. The bend may be where the belt passes over a wheel or roller. The belt may be an endless belt which returns the empty moulds to be filled again. The composition with which the moulds are filled may be an organic pre-polymer which is cured to a solid form by irradiation with ultra-violet light.

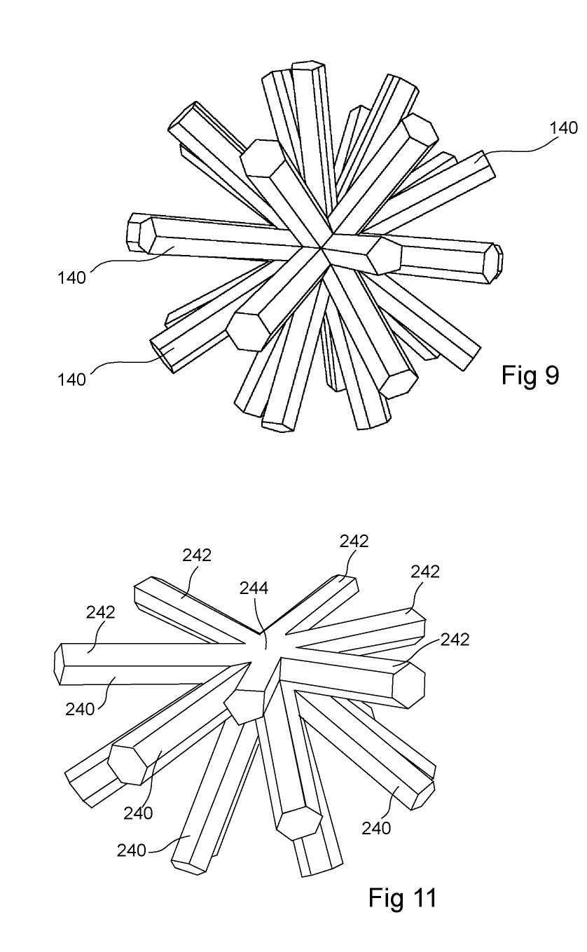

FIG. 10 shows an object which may be moulded in this way. It is similar to part of the object of FIG. 7. It has a main body 230 which is approximately hemispherical with a flat face 232 and a plurality of projections 234 from the body 230, although not from the flat face 232. The projections 234 are cones with a cone angle not exceeding 30° and terminating in a blunted point. Because the cone angle is not more than 30°, the included solid angle at each blunted point is not more than 0.78 steradians.

FIG. 11 shows another possible object which can be made by casting. Similarly to the object of FIG. 9, it has a small core with a number of projections 240 which extend outwards for a distance which is more than the distance across the core. The projections have polygonal cross-sections and some of them have faces 242 which all lie in a single flat plane. The core also has a surface area 244 contiguous with the surfaces 242 and lying in the same plane. Thus all parts of the object are at the same side of the plane of the surfaces 242.

The objects of FIG. 10 are moulded in the orientation shown in the drawing, in an open topped mould cavity, so that the surface of the liquid in the mould forms the flat face 232 of the object. Similarly the objects of FIG. 11 are moulded in the orientation shown in FIG. 11, so that the surface of the composition in the mould forms the surfaces 242, 244 which lie in a common plane. The tetragons of FIG. 7 could also be cast in open topped mould cavities with one point at the bottom of the cavity so that so that the surface of the liquid formed one flat face of the tetragon.

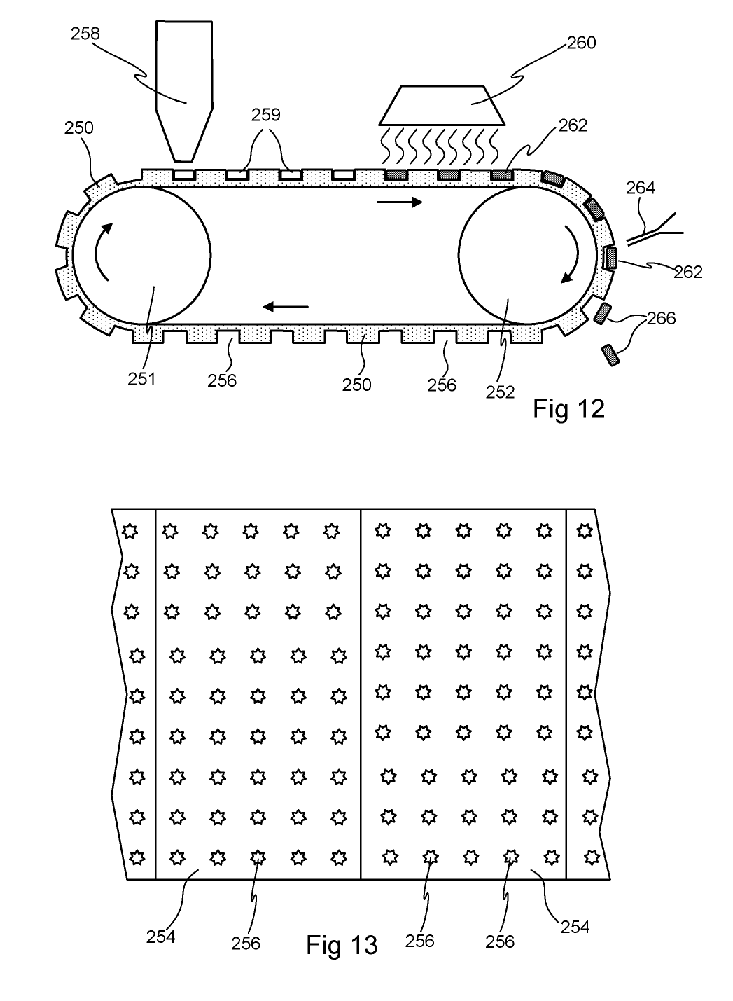

FIGS. 12 and 13 show apparatus for making objects, such as those of FIGS. 10 and 11. As shown by FIG. 12, the apparatus has an endless belt 250 running over rollers 251, 252 in the direction indicated by arrows. The belt 250 is made up of a number of rectangular sections 254 made of a flexible elastomeric material and joined together edge to edge.

As shown by FIG. 13 each section 254 has an array of individual mould cavities 256 extending inwardly from the exposed surface of the belt. In FIG. 13 the open mouths of the cavities 256 are shown as a star shape, as would be the case for making an object with projections from a central core. In FIG. 12 the cavities 256 are schematically indicated as rectangular.

As the belt 250 travels around the rollers 251, 252, a filling mechanism 258 dispenses a photocurable liquid composition into each cavity. Cavities containing liquid composition are indicated at 259. The belt then passes under lamps 260 which direct ultra-violet or visible light onto the belt, causing photocuring of the composition which polymerises and solidifies. The belt then passes around roller 252 where bending the elastomeric belt 250 causes the mouths of the cavities 256 to open, allowing the moulded objects 262 to be dislodged by a jet of air from nozzle 264 and fall out as shown at 266.

The photocurable liquid composition dispensed into the moulding cavities 256 by the filling mechanism 258 contains one or more materials capable of undergoing polymerisation, together with a photoinitiator such that exposure of the composition to visible or ultra-voilet radiation causes the photo initiator to liberate reactive species which react with the polymerisable material and cause polymerisation to begin.

The photo initiator is a compound that it is capable of generating a reactive species effective to initiate polymerisation upon absorption of actinic radiation preferably in the range from 250 to 800 nm. The initiating species which is generated may be a cation or a free radical.

A type I radical photo initiator undergoes a unimolecular bond cleavage (α-cleavage) upon irradiation to yield the free radical. A type II radical photo initiator undergoes a bimolecular reaction where the triplet excited state of the photoinitiator interacts with a second molecule, which may be another initiator molecule, to generate a free radical. Typically, the second molecule is a hydrogen donor. Where the second molecule is not another initiator molecule, it may be an amine, alcohol or ether acting as a coinitiator. Preferably, the coinitiator is an amine, most preferably a tertiary amine.

Type I cleavable photo-initators include benzoin ethers, dialkoxy acetophenones, phosphine oxide derivatives, amino ketones, e.g. 2-dimethyl, 2-hydroxyacetophenone, and bis(2,4,6-trimethyl benzoyl) phenyl phosphine oxide.

Type II initiator systems (photoinitiator and coinitiator) include aromatic ketones e.g. camphorquinone, thioxanthone, anthraquinone, 1-phenyl 1,2 propanedione, combined with H donors such as alcohols, or electron donors such as amines.

A cation photo-initiator is preferably a photoacid generator, typically a diazonium or onium salt, e.g. diaryliodonium or triarylsulphonium hexafluorophosphate.

Photo initiator will generally be a small percentage of the polymerisable composition. The percentage of photo initiator in the composition is likely to be a least 0.5% by weight and may extend up to 3% or even 5% by weight of the liquid components of the composition.

The polymerisable composition will generally comprise one or more polymerisable monomers which contain two groups able to participate in the polymerization reaction. Such monomers can extend a growing polymer chain and are likely to provide at least 50% probably at least 80% or 85% of the liquid components of the polymerizable composition. These monomers may be accompanied by a minor proportion of monomers with more than two groups able to participate in the polymerization reaction. Such monomers create branching of polymer chains or cross-linking between polymer chains and may be present as up to 15%, preferably 1 to 10% by weight of the liquid components of the polymerisable composition.

The groups able to participate in the polymerization reaction may be olefinically unsaturated groups. Polymerizable monomers may be esters of an olefinically unsaturated acid and a dihydroxy compound (although such esters may be manufactured using other starting materials such as an acid chloride, of course) The acid moiety is preferably an olefinically unsaturated acid containing 2 to 5 carbon atoms notably acrylic or methacrylic acid.

Some examples of such monomer compounds are: —

bisphenol A ethoxylate diacrylates, having the general formula

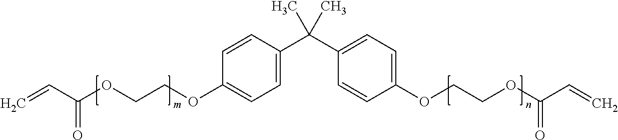

bisphenol A ethoxylate dimethacrylates, having the general formula

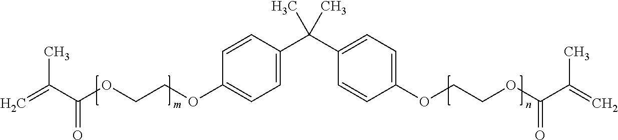

and poly(ethylene glycol) diacrylates having general formula:

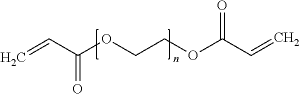

In the above three general formulae, m and n are average values and may vary. Generally they will lie in a range up to 15, such as 1 or 1.5 up to 15 but preferably not above 6. We have found that monomers containing ethylene oxide residues improve flexibility of the polymer but reduce its strength.

The composition preferably also includes some monomer with more than two olefinically unsaturated groups, to create branched or cross-linked polymer chains. Such compounds may be acrylate or methacrylate esters of poly hydroxy compounds. Some examples are as follows:

| | | MW |
|---|---|---|
| Name | Formula | (g/mol) |
| trimethylolpropane triacrylate | 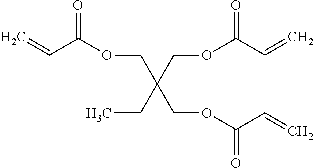 [SMILES: C=CC(=O)OCC(CC)(COC(=O)C=C)COC(=O)C=C] | 296 |
| trimethylolpropane ethoxylate triacrylate | 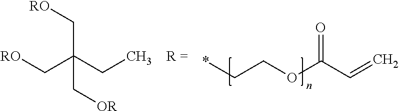 | |
| The average value of n in the above formula may be chosen so that the | | |
| mean molecular weight is about 430, about 600 or about 900 | | |
| pentaerythritol tetraacrylate | 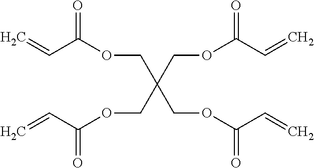 [SMILES: C=CC(=O)OCC(COC(=O)C=C)(COC(=O)C=C)COC(=O)C=C] | 352 |
| di(trimethylolprop- ane) tetraacrylate | 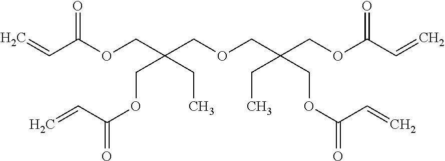 [SMILES: C=CC(=O)OCC(CC)(COCC(CC)(COC(=O)C=C)COC(=O)C=C)COC(=O)C=C] | 466 |

Monomer compounds with two olefinically unsaturated groups may also be vinyl ethers such as 1,6-hexane diol divinyl ether, poly(ethylene glycol) divinyl ether, bis-(4-vinyl oxy butyl)hexamethylenediurethane, and vinyl ether terminated esters such as bis-(4-vinyl oxy butyl) adipate and bis-(4-vinyl oxy butyl) isophthalate.

Another possibility is that the groups able to participate in the polymerization reaction are epoxide groups. A suitable category of monomer compounds containing epoxide groups are glycidyl ethers of dihydroxy compounds, some specific possibilities being 1,6-hexanediol diglycidyl ether, bisphenol A diglycidyl ether and poly(ethylene glycol) diglycidyl ether.

The polymerisable composition may comprise a mixture of monomers. Notably a mixture of monomers may be used in order to obtain a desired combination of mechanical properties of the polymer lining on the tubing. The monomers will generally provide at least 50 wt % of the composition and preferably from 70 to 99.5 wt % of it.

The polymerisable composition may include one or more solids serving to reinforce it after polymerisation. Such a solid material included to reinforce the composition may be particulate, such as bentonite clay particles, or may be short fibres such as chopped glass fibres. These materials may have an additional effect of enhancing viscosity. Another reason for including a solid would be to raise the specific gravity by adding a solid filler which is denser than the polymer. The polymerisable composition may contain from 0 to 20 wt % of such solids, possibly even up to 30 wt % or above.

Solid objects of polymeric material may have a size chosen to be the maximum which can pass through the jets 20 of the drill bit which is in use. Alternatively, they may be smaller than this maximum.

### Example 1

A drilling fluid contains approximately 100 gram per litre of inorganic solids having a mean particle size above 100 microns and below 500 microns. The fluid also contains

(a) 10 gram per litre of organic polymer objects made by shearing recycled plastic as described above with reference to FIGS. 5 and 6 and having size which would fit in a 2 mm diameter sphere but too large to fit within a lmm, diameter sphere, together with
(b) 10 gram per litre of organic polymer objects also made by shearing recycled plastic as described above with reference to FIGS. 5 and 6 but having size which would fit in a 5 mm diameter sphere but too large to fit within a 3 mm, diameter sphere.

The drilling fluid is used in drilling, as illustrated by FIG. 1. In the event that a fracture with a width of 1 to 4 mm is encountered, or formed as a result of pressure in a borehole, the polymer objects (a) would be carried into the fracture but would form a plug at the fracture mouth. Shapes with corners will snag on the rough surface of the rock and assist each other to form a plug to block entry into the fracture. Initially this plug would be porous but inorganic particles in the fluid would then lodge in the interstices between the organic polymer objects, sealing the plug and blocking further leakage into the formation.

If a larger fracture with a width of 4 to 8 mm is encountered or formed, the objects (b) would be carried into the fracture but would form a plug at the fracture mouth. The smaller objects (a) would lodge in gaps between the larger objects (b) creating a porous bridge which would then retain the smaller inorganic particles and so form a seal blocking further leakage into the fracture.

### Example 2

Another drilling fluid also contains approximately 100 gram per litre of inorganic solids having a mean particle size above 100 microns and below 500 microns. This fluid also contains

(a) 10 gram per litre of organic polymer objects made by shearing recycled plastic as described above with reference to FIGS. 5 and 6 and having size which would fit in a 2 mm diameter sphere but too large to fit within a lmm, diameter sphere, together with
(b) 5 gram per litre of organic polymer objects as shown in FIG. 10 having size which would fit in a 6 mm diameter sphere but too large to fit within a 3 mm, diameter sphere.

Once again, if a fracture with a width of 4 to 8 mm is encountered or formed, the objects (b) would be carried into the fracture but would form a plug at the fracture mouth. The smaller objects (a) would lodge in gaps between the larger objects (b) creating a porous bridge which would then retain the smaller inorganic particles and so form a seal blocking further leakage into the fracture.

### Example 3

Another drilling fluid also contains approximately 100 gram per litre of inorganic solids having a mean particle size above 100 microns and below 500 microns. This fluid also contains

(a) 5 gram per litre of organic polymer objects as shown in FIG. 11 having size which would fit in an 8 mm diameter sphere but too large to fit within a 5 mm, diameter sphere,
(b) 5 gm per litre of organic polymer objects as shown in FIG. 10 having size which would fit in a 6 mm diameter sphere but too large to fit within a 4 mm, diameter sphere, and
(c) 10 gram per litre of organic polymer objects made by shearing recycled plastic as described above with reference to FIGS. 5 and 6 and having size which would fit in a 2 mm diameter sphere but too large to fit within a 1 mm, diameter sphere.

It will be appreciated that the various embodiments described above are by way of example and can be modified and varied within the scope of the concepts which they exemplify. Features referred to above or shown in individual embodiments above may be used together in any combination as well as those which have been shown and described specifically. Accordingly, all such modifications are intended to be included within the scope of this disclosure as defined in the following claims.

1. A borehole fluid containing suspended solid particles which are objects formed of polymeric material with sufficient rigidity to sustain their own shape, wherein the objects have an overall size extending at least 0.5 mm in each of three orthogonal dimensions and wherein the objects have a shape such that each object has one or more edges, points or corners and/or comprises a core portion with a plurality of projections which extend out from the core portion.

2. A borehole fluid according to claim 1 wherein the objects have a shape which is at least partially bounded by surfaces which intersect at an edge.

3. A borehole fluid according to claim 1 wherein the objects have a shape where the angle included between surfaces intersecting at an edge is not more than 150°.

4. A borehole fluid according to claim 1 wherein at least some of the objects have a shape such that the object has one or more points or corners which include angles which are less than 90° when viewed in two orthogonal directions or which include a solid angle of less than than 0.5π steradians.

5. A borehole fluid according to claim 1 wherein at least some of the objects comprise a core with a plurality of projections which extend out from the core.

6. A borehole fluid according to claim 5 wherein the projections extend out from the core for a distance greater than a distance across the core.

7. A borehole fluid according to claim 1 wherein the objects are made of organic polymer with a specific gravity in a range from 0.8 to 1.2.

8. A borehole fluid according to claim 1 wherein at least some of the objects are too large to fit within a sphere of 1 mm diameter, but are able to fit within a sphere of 8 mm diameter.

9. A borehole fluid according to claim 1 wherein the objects are dimensioned such as to be too large to fit inside a sphere of 1.5 mm diameter but small enough to fit inside a sphere with a diameter of 6 mm.

10. A borehole fluid according to claim 1 also comprising solid particles other than the said objects.

11. A borehole fluid according to claim 10 wherein the particles other than the said objects have a mean particle size no greater than 1 mm.

12. A borehole fluid according to claim 10 wherein particles other than the said objects are present in a greater amount by weight than the said objects.

13. A method of mitigating loss of drilling fluid while drilling a borehole and circulating drilling fluid down and back up the borehole, comprising incorporating objects formed of polymeric material as defined in any one of the preceding claims in the drilling fluid.

14. A method according to claim 13 which further comprises making objects which are as defined in claim 1 and have intersecting surfaces, edges and/or corners using machinery in which pieces of polymeric material are sheared by cutting parts moving one past another close enough that the pieces of the polymer are sheared through.

15. A method according to claim 14 wherein more than 50% by weight of objects are formed of a thermoplastic polymer.
